(19) United States
(12) Patent Application Publication
(10) Pub. No.: US 2026/0200962 A1
(43) Pub. Date: Jul. 16, 2026

(54) REDOX COMPLEX AND PREPARATION METHOD THEREFOR AND USE THEREOF

(71) Applicant: SHENZHEN MUXIN TECHNOLOGY CO., LTD., SHENZHEN (CN)

(72) Inventors: MIN LIU, SHENZHEN (CN); JIN CAI, SHENZHEN (CN); CHANG ZHAN, SHENZHEN (CN)

(21) Appl. No.: 19/532,171

(22) Filed: Feb. 6, 2026

Related U.S. Application Data
(63) Continuation of application No. PCT/CN2023/128717, filed on Oct. 31, 2023.

(30) Foreign Application Priority Data
Aug. 8, 2023 (CN) 202310993993.6

(51) Int. Cl. C07F 15/00; G01N 27/327; G01N 27/48

(52) U.S. Cl. CPC C07F 15/0026; G01N 27/3271; G01N 27/48

(57) ABSTRACT

This application discloses a redox complex and preparation method therefor and use thereof. The redox complex contains a bridged 2,2′-biimidazole structure, through bridging two nitrogen atoms with active hydrogen, stabilizing the structure of the imidazole ring, preventing conformational isomerism of the 2,2′-biimidazole. When the bridged 2,2′-biimidazole structure coordinates with transition metals to form a complex, which significantly improves the efficiency and stability of the complex. Therefore, when the redox complex is used as the electron mediator in sensors, it exhibits a lower oxidation potential, while significantly extending the service life of the sensors.

### CROSS-REFERENCE TO RELATED APPLICATIONS

This application is a continuation of International Application No. PCT/CN2023/128717, filed on Oct. 31, 2023, which claims priority of Chinese Patent Application number 202310993993.6, filed on Aug. 8, 2023, the entire contents of which is incorporated herein by reference.

### TECHNICAL FIELD

The present disclosure relates to the technical field of medical diagnosis, and in particular to a redox complex and preparation method therefor and use thereof.

### BACKGROUND

The first-generation technology of continuous glucose monitoring sensors employs oxygen as an electron mediator. Glucose is oxidized by glucose oxidase to generate hydrogen peroxide. The reduction of hydrogen peroxide on the electrode induces electron transfer, forming an electric current, whereby the glucose concentration in the monitored liquid is determined based on the current magnitude. In other biosensors, such as electrochemical sensors for lactic acid, uric acid, blood lipids, and blood ketones, the concentration of biological substances in the liquid is similarly calculated by measuring the current magnitude. The second-generation technology replaces oxygen with synthetic organic complexes as the electron mediator, reducing the excitation voltage required for sensors, significantly enhancing their anti-interference performance, and thus gaining increasingly widespread application. In related technologies, ligand complexes formed by 2,2′-biimidazole coordinating with transitions metals serve as electron transfer media. However, because of the characteristic of conformational isomerism of 2,2′-biimidazole, the ligand complexes formed by 2,2′-biimidazole coordinating with transition metals suffer from issues such as low complexation efficiency or decomplexation during the synthesis process, resulting in poor stability and short service life of the sensors. It should be noted that the above content does not necessarily constitute the prior art, and isn't intended to limit the scope of the present disclosure patent protection.

### SUMMARY

The embodiments of the present disclosure provide a redox complex and preparation method therefor and use thereof, to solve or alleviate one or more of the technical problems mentioned above.

In one aspect of the embodiments of the present disclosure, the embodiment provides a redox complex, the redox complex is represented by formula I:

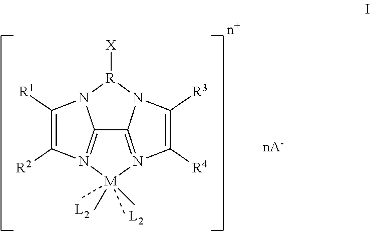

in formula I, R is a C₁-C₄ alkylene chain; X is each independently selected from a group consisting of hydroxyl, amino, ethenyl, alkynyl, azido, cyano, carboxyl, hydroxymethyl, sulfhydryl and isocyanate group; R¹, R², R³ and R⁴ are each independently hydrogen (H) or alkyl; M is a transition metal; n is the number of counter cations; A is a counterion; a structure of L₂ is represented in formula II:

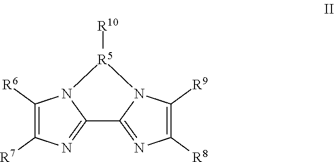

in formula II, R⁵ is each independently C₁-C₄ alkylene chain or ortho-substituted benzene ring; R¹⁰ is each independently hydrogen (H), —CH₃ or —CH₂CH₃;

Alternatively, the transition metal is each independently selected from a group consisting of iron (Fe), cobalt (Co), ruthenium (Ru), osmium (Os) and vanadium (V).

Alternatively, the counterion is each independently chloride ion or hexafluorophosphate.

In another aspect, the embodiment further provides a preparation method for the redox complex including the following steps:

A 2,2′-biimidazole is reacted with a first organic compound in a first reaction, to produce a first bridged 2,2′-biimidazole. The first organic compound is selected from a group consisting of 2,3-dibromo-1-propanol, 1,3-dibromo-2-propanol, and 1,4-dibromo-2-butanol.

The 2,2′-biimidazole is reacted with a second organic compound in a second reaction, to produce a second bridged 2,2′-biimidazole. The second organic compound is selected from a group consisting of 1,2-dibromoethane, 1,3-dibromopropane, 1,4-dibromobutane, and 1,2-bis(bromomethyl)benzene.

The first bridged 2,2′-biimidazole and the second bridged 2,2′-biimidazole are subjected to a third reaction through complexation with the transition metal to obtain the redox complex.

Alternatively, the step involved in reacting 2,2′-biimidazole with the first organic compound through the first reaction to obtain the first bridged 2,2′-biimidazole includes:

The 2,2′-biimidazole is reacted with one of sodium hydroxide, sodium hydride, or methyl p-toluenesulfonate to obtain a first reaction intermediate.

The first reaction intermediate is reacted with the first organic compound to obtain the first bridged 2,2′-biimidazole.

Alternatively, the step involved in reacting 2,2′-biimidazole with the second organic compound through the second reaction to obtain the second bridged 2,2′-biimidazole includes:

The 2,2′-biimidazole is reacted with one of sodium hydroxide, sodium hydride, or methyl p-toluenesulfonate to obtain a second reaction intermediate.

The second reaction intermediate and the second organic compound are subjected to a reaction, producing the second bridged 2,2′-biimidazole.

Alternatively, the first bridged 2,2′-biimidazole and the second bridged 2,2′-biimidazole are subjected to the third reaction through complexation with the transition metal to afford the redox complex, which includes:

The second bridged 2,2′-biimidazole and potassium hexachloroosmate are reacted in an organic solvent to obtain a third reaction intermediate, wherein the reaction temperature is 120-150° C., the reaction time is 12-36 h.

The third reaction intermediate and the first bridged 2,2′-biimidazole are reacted to obtain a fourth reaction intermediate, wherein the reaction temperature is 120-150° C., the reaction time is 12-36 h.

The fourth reaction intermediate is oxidized in air and then reacted with ammonium hexafluorophosphate to obtain the redox complex, wherein the oxidation time is 12-36 h.

Alternatively, the molar ratio of the first bridged 2,2′-biimidazole to the second bridged 2,2′-biimidazole is (1-4) to (1.3-3).

In another aspect, the embodiment further provides a preparation method for a sensing layer, including the following steps:

The redox complex, oxidase and a backbone polymer are dissolved in a HEPES buffer solution to obtain a sensing layer solution.

The sensing layer solution is coated onto an electrode surface to form the sensing layer.

In another aspect, the embodiment further provides a preparation method for the sensing electrode, including the following steps:

The sensing layer solution is applied onto a surface of a carbon electrode by spray-coating, drop-coating or dip-coating.

An outer membrane layer is applied onto the surface of the carbon electrode having the sensing layer by spray-coating or dip-coating to prepare the sensing electrode.

The embodiments of the present disclosure with the technical solutions described above, can be achieved the following advantages:

This application discloses the redox complex and preparation method therefor and use thereof. The redox complex contains a bridged 2,2′-biimidazole structure, through bridging two nitrogen atoms with active hydrogen, stabilizing the structure of the imidazole ring, preventing conformational isomerism of the 2,2′-biimidazole. When the bridged 2,2′-biimidazole structure coordinates with transition metals to form a complex, which significantly improves the efficiency and stability of the complex. Therefore, when the redox complex is used as the electron mediator in sensors, it exhibits a lower oxidation potential, while significantly extending the service life of the sensors.

### BRIEF DESCRIPTION OF DRAWINGS

In the accompanying drawings, unless otherwise specified, the identical reference numerals throughout the several figures indicate the same or similar parts or elements. These drawings are not necessarily drawn to scale. These drawings merely depict some embodiments disclosed in this application and should not be construed as limiting the scope of the application.

FIG. 1 is a cyclic voltammetry diagram of a redox complex prepared in embodiments 4-8 according to the present disclosure.

FIG. 2 is a relationship diagram between glucose concentration and current intensity in the embodiment according to the present disclosure.

FIG. 3 is a change diagram in current intensity of the sensing electrode over time in the embodiment according to the present disclosure.

### DESCRIPTION OF EMBODIMENTS

In order to make the objectives, technical solutions, and advantages of the present application more clear. The present application will be described in further detail with reference to the accompanying drawings and embodiments. It should be noted that the embodiments in the present application and the features of the embodiments may be combined with each other in the case of no conflict. The present application will be described in detail below with reference to the accompanying drawings and in conjunction with the embodiments.

It should be noted that the terms “first”, “second”, etc. in the specification and claims of the present application and the above-mentioned drawings are used to distinguish similar objects, and are not necessarily used to describe a specific order or sequence. It should be understood that the terms used in this way can be interchangeable where appropriate, so that the embodiments of the present application described herein can be implemented in an order other than those illustrated or described herein, for example. In addition, the terms “including” and “having” and any of their variations are intended to cover non-exclusive inclusions, for example, a process, method, system, product or device that includes a series of steps or units is not necessarily limited to those steps or units that are clearly listed, but may include other steps or units that are not clearly listed or inherent to these processes, methods, products or devices.

To facilitate those skilled in the art to understand the technical solutions provided in the embodiments of the present disclosure, the relevant technologies are described below.

The ligand complexes formed by 2,2′-biimidazole coordinating with transition metals have a pentacyclic structure, which exhibit issues such as low complexation efficiency, decomplexation and poor stability, thus resulting in a short service life of the sensor.

Therefore, the present disclosure provides a redox complex and preparation method therefor and use thereof. Furthermore, when the redox complex is utilized as an electron mediator in sensors and exhibits relatively low oxidation potential, significantly extending the service life of the sensor. More details are as follows.

In the following, these embodiments according to the present disclosure will be described in more detail with reference to the accompanying drawings. It should be understood that these embodiments may be implemented in various forms and should not be construed as limited to the embodiments described herein.

### Embodiment 1

The embodiment of the present disclosure provides a redox complex represented by the following formula I:

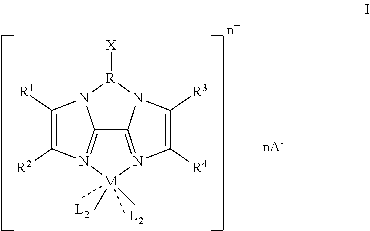

in formula I, R is a C₁-C₄ alkylene chain; X is each independently selected from a group consisting of hydroxyl, amino, ethenyl, alkynyl, azido, cyano, carboxyl, hydroxymethyl, sulfhydryl and isocyanate group. These functional groups react with the polymer resin to coordinate the redox complex on the polymer backbone via chemical bonds, thereby preventing the redox complex from migrating and diffusing into human tissue fluid, further enhancing the service life and safety of the sensing electrode prepared using the redox complex as the electron mediator. R¹, R², R³ and R⁴ are each independently hydrogen (H) or alkyl; M is a transition metal; n is the number of counter cations; A is a counterion; the L₂ is represented by the formula II:

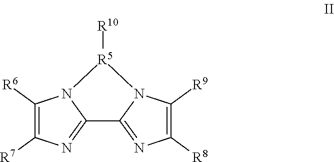

in formula II, R⁵ is each independently C₁-C₄ alkylene chain or ortho-substituted benzene ring; R¹⁰ is each independently hydrogen (H), —CH₃ or —CH₂CH₃. Specifically, the transition metal is each independently selected from a group consisting of iron (Fe), cobalt (Co), ruthenium (Ru), osmium (Os) and vanadium (V); the counterion is each independently chloride ion or hexafluorophosphate.

In the embodiment of the present disclosure provides a redox complex and preparation method therefor and use thereof. The redox complex contains a bridged 2,2′-biimidazole structure, through bridging two nitrogen atoms with active hydrogen, stabilizing the structure of the imidazole ring, preventing conformational isomerism of the 2,2′-biimidazole. When the bridged 2,2′-biimidazole structure coordinates with transition metals to form the redox complex, which significantly improves the efficiency and stability of the redox complex. Therefore, when the redox complex is used as the electron mediator in sensors, it exhibits the lower oxidation potential, while significantly extending the service life of the sensors.

### Embodiment 2

The embodiment of the present disclosure provides the redox complex represented by the following formula III:

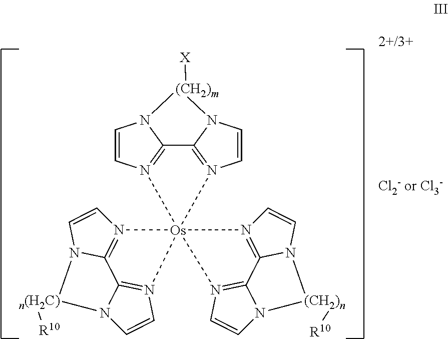

X is a functional group such as hydroxyl, amino, ethenyl, alkynyl, azido, cyano, carboxyl, hydroxymethyl, sulfhydryl or isocyanate group; m is 2, 3, or 4; n is each independently 2, 3, 4 or ortho-substituted benzene ring; R¹⁰ is each independently hydrogen (H), —CH₃ or —CH₂CH₃.

In some embodiments, the redox complex represented by formulas (1) to (21).

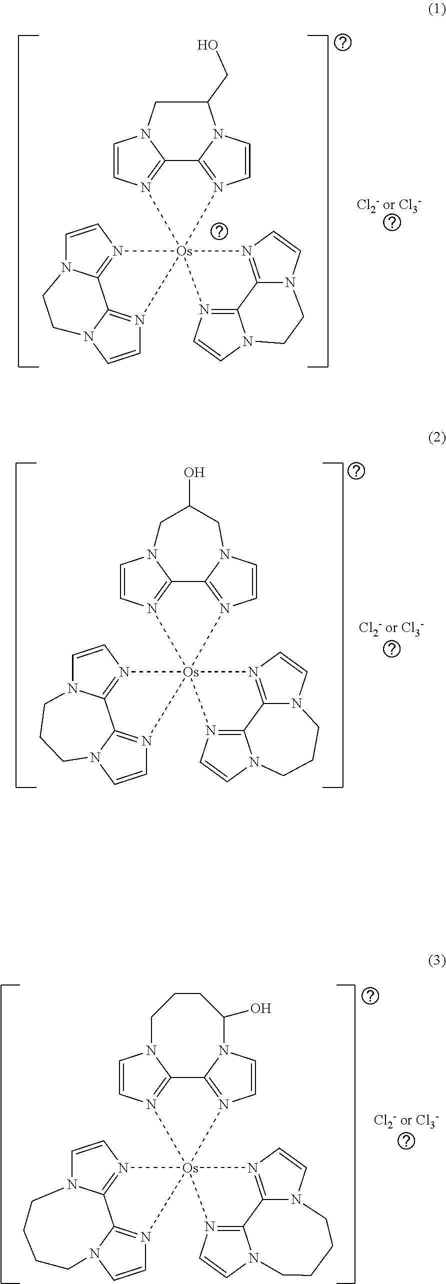

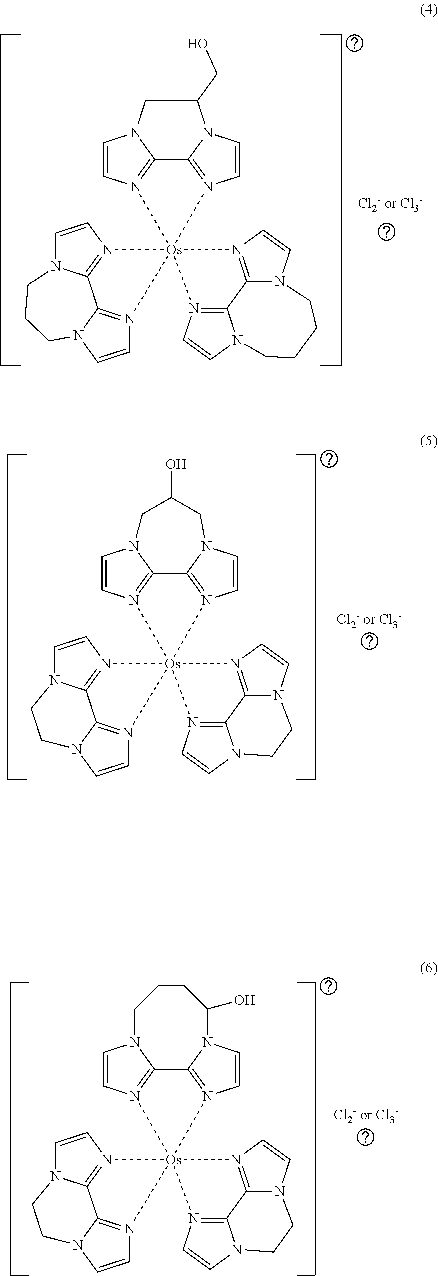

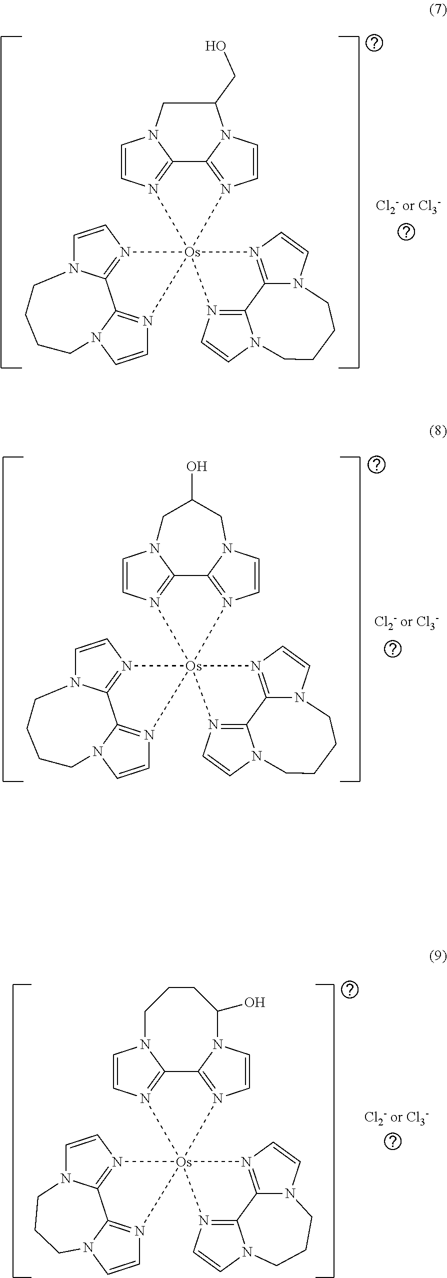

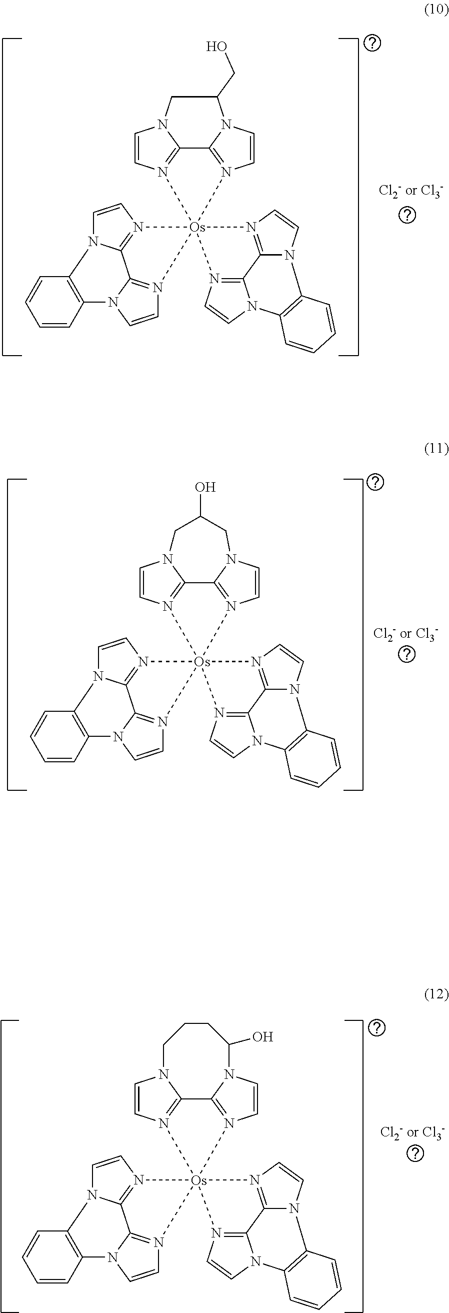

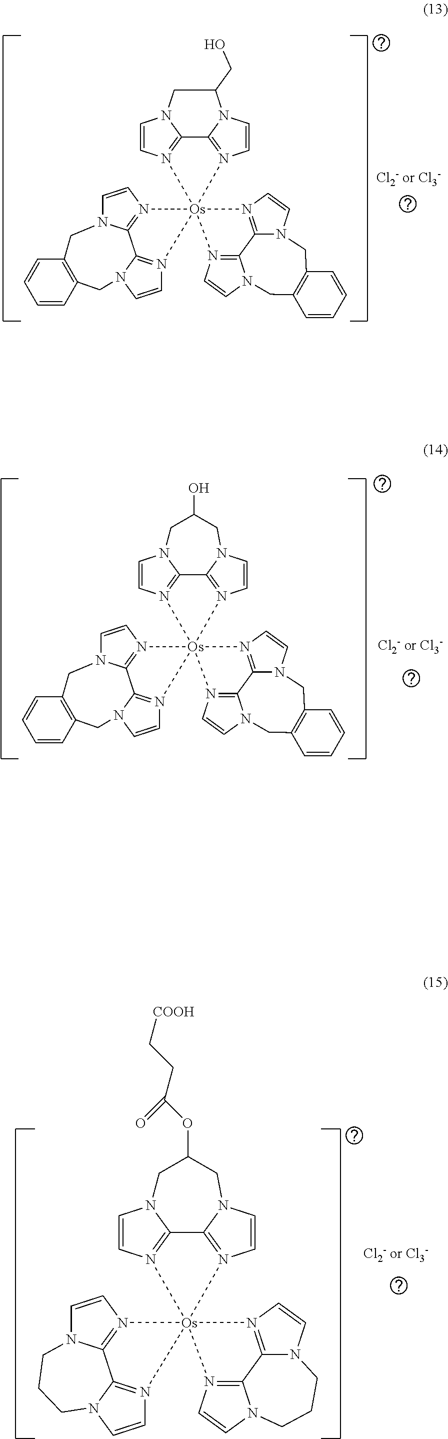

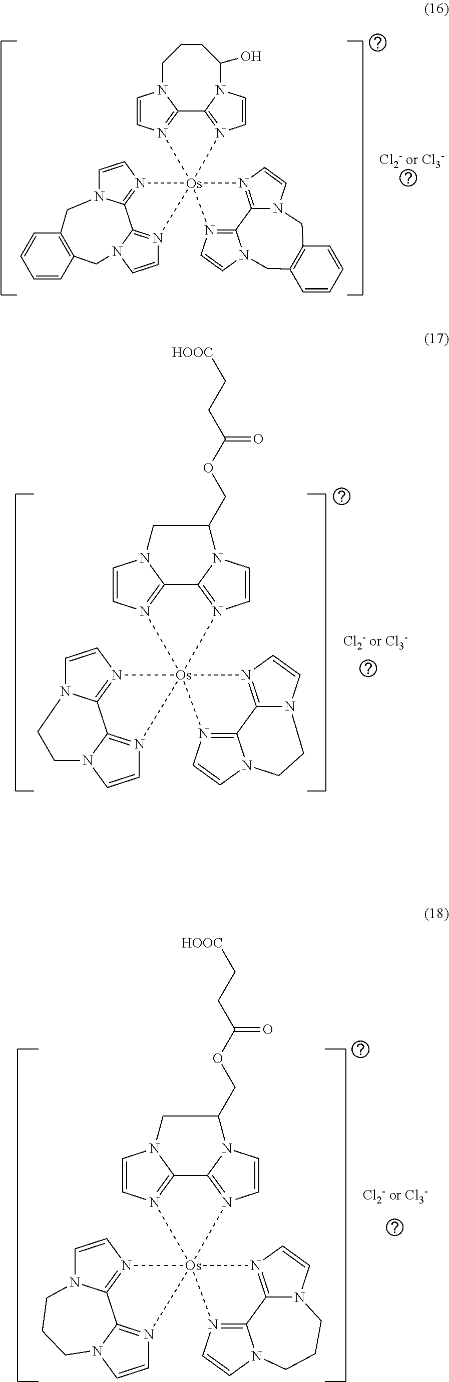

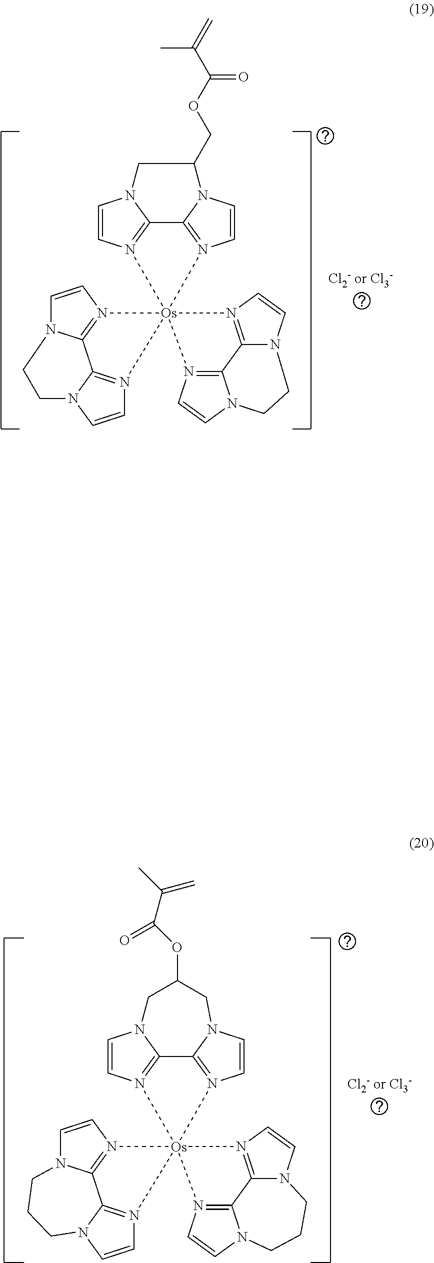

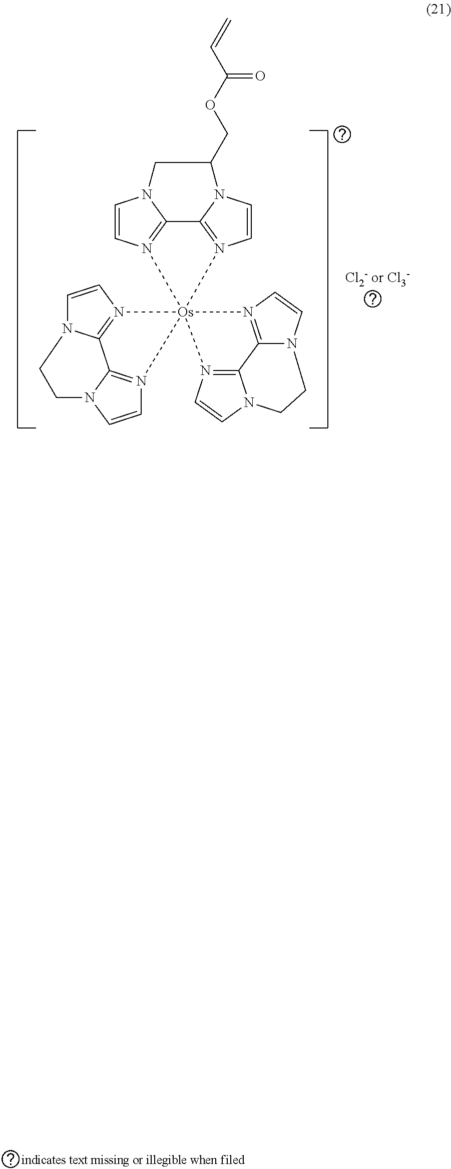

When the redox complexes are used as the electron mediators in biosensors, they exhibit superior chemical stability, lower oxidation peaks, wider linear range and long-term sensitivity stability.

### Embodiment 3

The embodiment of the present disclosure further provides a method for preparing a redox complex, including the following steps.
S300, the 2,2′-biimidazole is reacted with the first organic compound in the first reaction, to obtain the first bridged 2,2′-biimidazole. The first organic compound is selected from a group consisting of 2,3-dibromo-1-propanol, 1,3-dibromo-2-propanol, and 1,4-dibromo-2-butanol.

In some embodiments, S300 further including:
S300A, the 2,2′-biimidazole is reacted with one of sodium hydroxide, sodium hydride, or methyl p-toluenesulfonate to obtain the first reaction intermediate.
S300B, the first reaction intermediate is reacted with the first organic compound, producing the first bridged 2,2′-biimidazole.
S302, the 2,2′-biimidazole is reacted with the second organic compound in the second reaction, to produce the second bridged 2,2′-biimidazole. The second organic compound is selected from a group consisting of 1,2-dibromoethane, 1,3-dibromopropane, 1,4-dibromobutane, and 1,2-bis(bromomethyl)benzene.

In some embodiments, S302 further including:
S302A, the 2,2′-biimidazole is reacted with one of sodium hydroxide, sodium hydride, or methyl p-toluenesulfonate to obtain the second reaction intermediate.
S302B, the second reaction intermediate is reacted with the second organic compound, producing the second bridged 2,2′-biimidazole.
S304, the first bridged 2,2′-biimidazole and the second bridged 2,2′-biimidazole are subjected to the third reaction via complexation with the transition metal to afford the redox complex, wherein, the molar ratio of the first bridged 2,2′-biimidazole to the second bridged 2,2′-biimidazole is (1-4) to (1.3-3).

In some embodiments, S304 further including:
S304A, the second bridged 2,2′-biimidazole and potassium hexachloroosmate are reacted in the organic solvent to obtain the third reaction intermediate, wherein the reaction temperature is 120-150° C., the reaction time is 12-36 h.
S304B, the third reaction intermediate is reacted with the second bridged 2,2′-biimidazole to obtain the fourth reaction intermediate, wherein the reaction temperature is 120-150° C., the reaction time is 12-36 h.
S304C, the fourth reaction intermediate is oxidized in air and then reacted with ammonium hexafluorophosphate to obtain the redox complex, wherein the oxidation time is 12-36 h.

### Embodiment 4

Taking the redox complex of formula (1) in embodiment 2 as an example, the preparation method thereof is further described as follows:
S400, synthesis of 1,1′-bis(1-hydroxymethyl)methylene-2,2′-biimidazole.

The 2,2′-biimidazole (0.7 g, 5.2 mmol) and N,N-dimethylformamide (10 mL) were added to a reaction flask, after which stirring was performed to achieve homogeneity. Subsequently, sodium hydroxide (0.46 g, 11.5 mmol) was incorporated, and stirring was continued at room temperature for 0.5 h. Thereafter, 2,3-dibromo-1-propanol (1.2 g, 5.5 mmol) was added, with stirring maintained at room temperature for 24 h. The reaction mixture was cooled to room temperature, and insoluble solid particles were removed by filtration. Next, the filtrate was subjected to rotary evaporation to eliminate N,N-dimethylformamide. The crude product was ultrasonically washed with hot acetonitrile three times, and the washing solutions were collected. Finally, acetonitrile was removed by rotary evaporation to obtain a pale-yellow solid powder (0.36 g, 36.3%). The ¹H NMR data of the resulting product are as follows:

¹HNMR(400 MHz,(CD₃)₂SO) δ (ppm): 7.30 (d, 2H), 7.02 (d, 2H), 4.40 (d, 2H), 3.95-3.88 (m, 1H), 4.20-4.16 (d, 2H), 2.74-2.73 (d, 1H).
S402, synthesis of 1,1′-dimethylene-2,2′-biimidazole.

The 2,2′-biimidazole (1.0 g, 7.43 mmol) and N,N-dimethylformamide (10 mL) were added to a reaction flask, after which stirring was performed to achieve homogeneity. Subsequently, sodium hydroxide (0.66 g, 16.3 mmol) was incorporated, and stirring was continued at room temperature for 0.5 h. Thereafter, 1,2-dibromoethane (1.54 g, 8.17 mmol) was added, with stirring maintained at room temperature for 24 h. The reaction mixture was cooled to room temperature, and insoluble solid particles were removed by filtration. Next, the filtrate was subjected to rotary evaporation to eliminate N,N-dimethylformamide. The crude product was ultrasonically washed with hot acetonitrile three times, and the washing solutions were collected. Finally, acetonitrile was removed by rotary evaporation to obtain a pale-yellow solid powder (0.42 g, 35%). The ¹H NMR data of the resulting product are as follows:

¹H NMR (400 MHz,(CD₃)₂SO) δ (ppm): 7.30 (d, 2H), 7.01 (d, 2H), 4.30 (s, 4H).
S404, synthesis of the redox complex (1).

The 1,1′-dimethylene-2,2′-biimidazole (0.2 g, 1.2 mmol) and potassium hexachloroosmate (0.33 g, 0.7 mmol) were added to a reaction flask, then the ethylene glycol (10 ml) was incorporated, after which stirring was performed to achieve homogeneity. Thereafter, with stirring maintained under 140° C. for 24 h. Subsequently, a mixture of 1,1′-bis(1-hydroxymethyl)methylene-2,2′-biimidazole (0.18 g, 0.9 mmol) and ethylene glycol (5 ml) was introduced, with stirring continued for another 24 h.

The reaction mixture was cooled to room temperature. The insoluble solid impurities were removed through suction filtration. Next, the deionized water (20 mL) was added to the filtration, and the mixture was stirred in an open beaker at room temperature for 24 h to allow oxidation to proceed. Subsequently, the oxidized solution was added dropwise to an ammonium hexafluorophosphate solution (10.0 g, 100 mL), causing precipitation to form. The precipitation was collected via suction filtration to afford a brown-black solid powder (0.16 g, 26.7%), which was the redox complex (1).

### Embodiment 5

Taking the redox complex represented by the structure of formula (2) in embodiment 2 of the present disclosure as an example, the preparation method of the redox complex is further illustrated.
S500, synthesis of the 1,1′-tris(2-hydroxy)methylene-2,2′-biimidazole.

The 2,2′-biimidazole (0.7 g, 5.2 mmol) and N,N-dimethylformamide (10 mL) were added to a reaction flask, after which stirring was performed to achieve homogeneity. Subsequently, sodium hydroxide (0.46 g, 11.5 mmol) was incorporated, and stirring was continued at room temperature for 0.5 h. Thereafter, 1,3-dibromo-2-propano (1.2 g, 5.5 mmol) was added, with stirring maintained at room temperature for 24 h. The reaction mixture was cooled to room temperature, and insoluble solid particles were removed by filtration. Next, the filtrate was subjected to rotary evaporation to eliminate N,N-dimethylformamide. The crude product was ultrasonically washed with hot acetonitrile three times, and the washing solutions were collected. Finally, acetonitrile was removed by rotary evaporation to obtain a pale-yellow solid powder (0.46 g, 46%). The ¹H NMR data of the resulting product are as follows:

¹HNMR(400 MHz,(CD₃)₂SO) δ (ppm): 7.30 (d, 2H), 7.02 (d, 2H), 4.06 (d, 4H), 3.85-3.78 (m, 1H), 2.75-2.73 (d, 1H).
S502, synthesis of the 1,1′-trimethylene-2,2′-biimidazole.

The 2,2′-biimidazole (1.0 g, 7.43 mmol) and N,N-dimethylformamide (10 mL) were added to a reaction flask, after which stirring was performed to achieve homogeneity. Subsequently, sodium hydroxide (0.66 g, 16.3 mmol) was incorporated, and stirring was continued at room temperature for 0.5 h. Thereafter, 1,3-dibromopropane (1.6 g, 8.17 mmol) was added, with stirring maintained at room temperature for 24 h. The reaction mixture was cooled to room temperature, and insoluble solid particles were removed by filtration. Next, the filtrate was subjected to rotary evaporation to eliminate N,N-dimethylformamide. The crude product was ultrasonically washed with hot acetonitrile three times, and the washing solutions were collected. Finally, acetonitrile was removed by rotary evaporation to obtain a pale-yellow solid powder (0.32 g, 25.3%). The ¹H NMR data of the resulting product are as follows:

¹HNMR(400 MHz,(CD₃)₂SO) δ (ppm): 7.30 (d, 2H), 7.01 (d, 2H), 4.40-4.32 (m, 4H), 2.45-2.41 (m, 2H).
S504, synthesis of the redox complex (2).

The 1,1′-trimethylene-2,2′-biimidazole (0.2 g, 1.2 mmol) and potassium hexachloroosmate (0.33 g, 0.7 mmol) were added to a reaction flask, then the ethylene glycol (10 ml) was incorporated, after which stirring was performed to achieve homogeneity. Thereafter, with stirring maintained under 140° C. for 24 h. Subsequently, a mixture of 1,1′-tris(2-hydroxy)methylene-2,2′-biimidazole (0.18 g, 0.9 mmol) and ethylene glycol (5 ml) was introduced, with stirring continued for another 24 h.

The reaction mixture was cooled to room temperature. The insoluble solid impurities were removed through suction filtration. Next, the deionized water (20 mL) was added to the filtration, and the mixture was stirred in an open beaker at room temperature for 24 h to allow oxidation to proceed. Subsequently, the oxidized solution was added dropwise to an ammonium hexafluorophosphate solution (10.0 g, 100 mL), causing precipitation to form. The precipitation was collected via suction filtration to afford a brown-black solid powder (0.21 g, 35%), which was the redox complex (2).

### Embodiment 6

Taking the redox complex represented by the structure of formula (3) in embodiment 2 of the present disclosure as an example, the preparation method of the redox complex is further illustrated.
S600, synthesis of the 1,1′-tetrakis(2-hydroxy)methylene-2,2′-biimidazole.

The 2,2′-biimidazole (0.7 g, 5.2 mmol) and N,N-dimethylformamide (10 mL) were added to a reaction flask, after which stirring was performed to achieve homogeneity. Subsequently, sodium hydroxide (0.46 g, 11.5 mmol) was incorporated, and stirring was continued at room temperature for 0.5 h. Thereafter, 1,4-dibromo-2-butanol (1.28 g, 5.5 mmol) was added, with stirring maintained at room temperature for 24 h. The reaction mixture was cooled to room temperature, and insoluble solid particles were removed by filtration. Next, the filtrate was subjected to rotary evaporation to eliminate N,N-dimethylformamide. The crude product was ultrasonically washed with hot acetonitrile three times, and the washing solutions were collected. Finally, acetonitrile was removed by rotary evaporation to obtain a pale-yellow solid powder (0.31 g, 29.2%). The ¹H NMR data of the resulting product are as follows:

¹HNMR(400 MHz,(CD₃)₂SO) δ (ppm): 7.30 (d, 2H), 7.02 (d, 2H), 5.85-5.78 (m, 1H), 4.56 (s, 1H), 3.95-3.88 (m, 2H), 2.22-2.18 (m, 2H), 2.05-1.93 (m, 2H).
S602, synthesis of the 1,1′-tetramethylene-2,2′-biimidazole.

The 2,2′-biimidazole (1.0 g, 7.43 mmol) and N,N-dimethylformamide (10 mL) were added to a reaction flask, after which stirring was performed to achieve homogeneity. Subsequently, sodium hydroxide (0.66 g, 16.3 mmol) was incorporated, and stirring was continued at room temperature for 0.5 h. Thereafter, 1,4-dibromobutane (1.76 g, 8.17 mmol) was added, with stirring maintained at room temperature for 24 h. The reaction mixture was cooled to room temperature, and insoluble solid particles were removed by filtration. Next, the filtrate was subjected to rotary evaporation to eliminate N,N-dimethylformamide. The crude product was ultrasonically washed with hot acetonitrile three times, and the washing solutions were collected. Finally, acetonitrile was removed by rotary evaporation to obtain a pale-yellow solid powder (0.44 g, 31.5%). The ¹H NMR data of the resulting product are as follows:

¹HNMR(400 MHz,(CD₃)₂SO) δ (ppm): 7.30 (d, 2H), 7.01 (d, 2H), 3.90-3.84 (m, 4H), 1.95-1.78 (m, 4H).
S604, synthesis of the redox complex (3).

The 1,1′-tetramethylene-2,2′-biimidazole (0.21 g, 1.1 mmol) and potassium hexachloroosmate (0.33 g, 0.7 mmol) were added to a reaction flask, then the ethylene glycol (10 ml) was incorporated, after which stirring was performed to achieve homogeneity. Thereafter, with stirring maintained under 160° C. for 24 h. Subsequently, a mixture of 1,1′-tetrakis(2-hydroxy)methylene-2,2′-biimidazole (0.19 g, 0.9 mmol) and ethylene glycol (5 ml) was introduced, with stirring continued for another 24 h.

The reaction mixture was cooled to room temperature. The insoluble solid impurities were removed through suction filtration. Next, the deionized water (20 mL) was added to the filtration, and the mixture was stirred in an open beaker at room temperature for 24 h to allow oxidation to proceed. Subsequently, the oxidized solution was added dropwise to an ammonium hexafluorophosphate solution (10.0 g, 100 mL), causing precipitation to form. The precipitation was collected via suction filtration to afford a brown-black solid powder (0.21 g, 33.9%), which was the redox complex (3).

### Embodiment 7

Taking the redox complex represented by the structure of formula (5) in embodiment 2 of the present disclosure as an example, the preparation method of the redox complex is further illustrated.
S700, synthesis of the 1,1′-tris(2-hydroxy)methylene-2,2′-biimidazole.

This step is the same as step S500 in embodiment 5.
S702, synthesis of 1,1′-dimethylene-2,2′-biimidazole.

This step is the same as step S402 in embodiment 4.
S704, synthesis of the redox complex (5).

The 1,1′-dimethylene-2,2′-biimidazole (0.2 g, 1.2 mmol) and potassium hexachloroosmate (0.33 g, 0.7 mmol) were added to a reaction flask, then the ethylene glycol A(10 ml) was incorporated, after which stirring was performed to achieve homogeneity. Thereafter, with stirring maintained under 140° C. for 24 h. Subsequently, a mixture of 1,1′-tris(2-hydroxy)methylene-2,2′-biimidazole (0.18 g, 0.9 mmol) and ethylene glycol (5 ml) was introduced, and the temperature was raised to 160° C., with stirring continued for another 24 h.

The reaction mixture was cooled to room temperature. The insoluble solid impurities were removed through suction filtration. Next, the deionized water (20 mL) was added to the filtration, and the mixture was stirred in an open beaker at room temperature for 24 h to allow oxidation to proceed. Subsequently, the oxidized solution was added dropwise to an ammonium hexafluorophosphate solution (10.0 g, 100 mL), causing precipitation to form. The precipitation was collected via suction filtration to afford a brown-black solid powder (0.16 g, 26.7%), which was the redox complex (5).

### Embodiment 8

Taking the redox complex represented by the structure of formula (13) in embodiment 2 of the present disclosure as an example, the preparation method of the redox complex is further illustrated.
S800, synthesis of 1,1′-bis(1-hydroxymethyl)methylene-2,2′-biimidazole.

This step is the same as step S400 in embodiment 4.
S802, synthesis of the 1,1′-α,α′-o-dibenzyl-2,2′-biimidazole.

The 2,2′-biimidazole (1.0 g, 7.43 mmol) and N,N-dimethylformamide (10 mL) were added to a reaction flask, after which stirring was performed to achieve homogeneity. Subsequently, sodium hydroxide (0.66 g, 16.3 mmol) was incorporated, and stirring was continued at room temperature for 0.5 h. Thereafter, 1,2-bis(bromomethyl)benzene (2.16 g, 8.17 mmol) was added, with stirring maintained at room temperature for 24 h. The reaction mixture was cooled to room temperature, and insoluble solid particles were removed by filtration. Next, the filtrate was subjected to rotary evaporation to eliminate N,N-dimethylformamide. The crude product was ultrasonically washed with hot acetonitrile three times, and the washing solutions were collected. Finally, acetonitrile was removed by rotary evaporation to obtain a pale-yellow solid powder (0.54 g, 30%). The ¹H NMR data of the resulting product are as follows:

¹HNMR(400 MHz,(CD₃)₂SO) δ (ppm): 7.34 (d, 2H), 7.05 (d, 2H), 7.15-7.11 (m, 4H), 5.25 (d, 4H).
S804, synthesis of the he redox complex (13).

The 1,1′-α,α′-o-dibenzyl-2,2′-biimidazole (0.28 g, 1.2 mmol) and potassium hexachloroosmate (0.33 g, 0.7 mmol) were added to a reaction flask, then the ethylene glycol (10 ml) was incorporated, after which stirring was performed to achieve homogeneity. Thereafter, with stirring maintained under 160° C. for 24 h. Subsequently, a mixture of 1,1′-bis(1-hydroxymethyl)methylene-2,2′-biimidazole (0.18 g, 0.9 mmol) and ethylene glycol (5 ml) was introduced, with stirring continued for another 24 h.

The reaction mixture was cooled to room temperature. The insoluble solid impurities were removed through suction filtration. Next, the deionized water (20 mL) was added to the filtration, and the mixture was stirred in an open beaker at room temperature for 24 h to allow oxidation to proceed. Subsequently, the oxidized solution was added dropwise to an ammonium hexafluorophosphate solution (10.0 g, 100 mL), causing precipitation to form. The precipitation was collected via suction filtration to afford a brown-black solid powder (0.16 g, 23.5%), which was the redox complex (13).

### Embodiment 9

Taking the sensing layer of a glucose electrochemical sensor as an example, the preparation method of the sensing layer is further illustrated.

### 1. Preparation of the Sensing Layer for the Glucose Electrochemical Sensor.

The present disclosure further provides a method for preparing the sensing layer of the glucose electrochemical sensor, including the following steps:
S900, the redox complexes prepared in embodiments 4 to 8, glucose oxidase, and poly(glycidyl methacrylate) were dissolved in HEPES buffer solution to obtain the sensing layer solution. In another embodiments, if it needs to prepare other sensing layers (such as sensing layers for lactic acid, uric acid, blood lipids, and blood ketones), the glucose oxidase needs to be replaced with the corresponding enzymes.

Specifically, glucose oxidase (7.0 mg), poly(glycidyl methacrylate) (1.0 g), and the redox complex prepared in the above embodiments were added to HEPES buffer solution (0.5 mL) and mixed uniformly using a shaker to obtain the sensing layer solution.
S902, the sensing layer solution was coated onto the electrode surface to form the glucose sensing layer.

Specifically, 3 μL of the sensing layer solution was pipetted and drop-coated onto the surface of a 3 mm glassy carbon electrode with clean and contaminant-free surface, then left at room temperature for 48 h to form a sensing film layer on the glassy carbon electrode. After completely drying, the glucose sensing layers A1-A5 were obtained.

### 2. Determination of Redox Peak Potentials for the Sensing Layer of the Glucose Electrochemical Sensor.

The sensing layers A1-A5 were immersed in standard PBS buffer solution (pH 7.4, 150 mM NaCl). The voltage range was set from −1.0 V to 1.0 V, with scan rate of 0.1 V/s and 5 cycles.

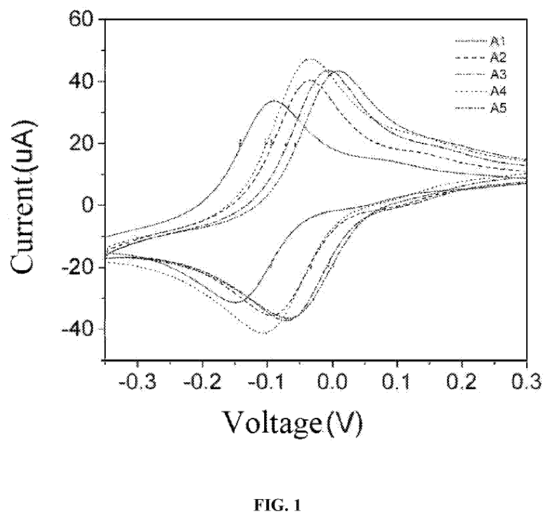

FIG. 1 is a cyclic voltammetry diagram of a redox complex prepared in the embodiments 4 to 8 according to the present disclosure. Referring to FIG. 1, the potentials of the redox complexes prepared in the embodiments 4 to 8 were less than 10 mV. Thus, the electrochemical catalytic oxidation of glucose can be achieved at a lower potential, avoiding interference to blood glucose monitoring results, which caused by the simultaneous occurrence of other biological reactions in the human body and the oxidation process of glucose under high-potential conditions, thereby improving the selectivity and accuracy of blood glucose monitoring.

### Embodiment 10

Taking the glucose electrochemical sensing electrode as an example, the embodiment of the present disclosure further illustrates the preparation method of the glucose electrochemical sensing electrode.

### 1. Preparation of the Glucose Electrochemical Sensing Electrode.

The present disclosure further provides a method for preparing the glucose electrochemical sensing electrode, including the following steps:
S100, the sensing layer prepared in embodiment 9 was applied to the surface of the carbon electrode by spray-coating, drop-coating, or dip-coating.
S102, the outer membrane layer is applied onto the surface of the carbon electrode having the sensing layer by spray-coating or dip-coating to prepare the glucose electrochemical sensing electrode.

Specifically, the sensing layer solution prepared in embodiment 9 is applied onto the surface of the carbon printed electrode by spray-coating, drop-coating, or dip-coating. As the solvent volatilized, the various compounds crosslink, gradually forming a film layer. After drying at room temperature for 48 h, an outer polymer layer is coated onto the electrode surface by dip-coating, followed by another 48 h of drying at room temperature to obtain the glucose sensing electrode.

The glucose sensing electrode exhibits low oxidation peak working potential and long-term sensitivity stability, and safety performance. Because the redox complex proposed in the embodiments can coordinate with the polymer resin through its functional groups, and be associated with the polymer backbone through chemical bonds. This prevents the redox complex from migrating and diffusing into human tissue fluid, further improving the service life and safety of the sensing electrode. In another embodiments, the sensing electrode can be a glucose electrochemical sensing electrode, a uric acid electrochemical sensing electrode, a blood ketone electrochemical sensing electrode, or a lactic acid electrochemical sensing electrode.

### 2. Sensor Electrode Linearity Test.

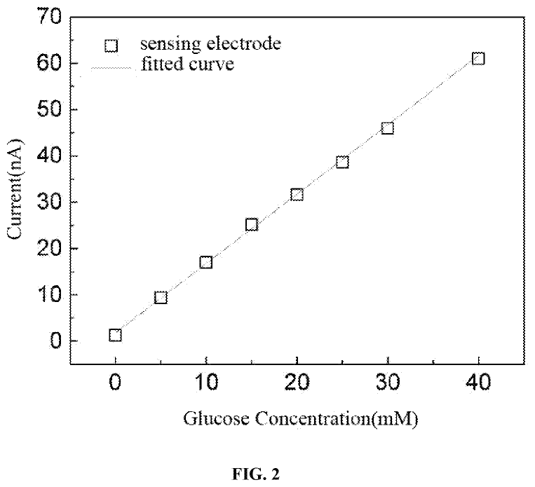

The sensing electrode was immersed in standard PBS buffer (pH 7.4, 150 mM NaCl), and then an initial pulse of 1.1 V was applied to the solution for 360 s. The remaining measurement was conducted on the sensor at 0.6 V. After waiting 10 min for the sensor to reach a stable level, glucose solutions with concentrations of 5.0, 10.0, 15.0, 20.0, 25.0, 30.0, and 40.0 mM were added to the solution and to measure the linearity of the response. After each addition of glucose, the solution was allowed to equilibrate for 3 min. The solution was continuously stirred to ensure uniform concentration. FIG. 2 is the relationship between glucose concentration and current intensity provided in the embodiment. Referring to FIG. 2, the sensor exhibits excellent linearity over the glucose concentration range 5 to 40 mM. This means that all the electrons generated during glucose oxidation are rapidly transferred to the electrode, improving the efficiency of electron transfer during glucose oxidation, and enhancing the sensitivity of blood glucose monitoring.

### 3. Sensing Electrode Stability Test.

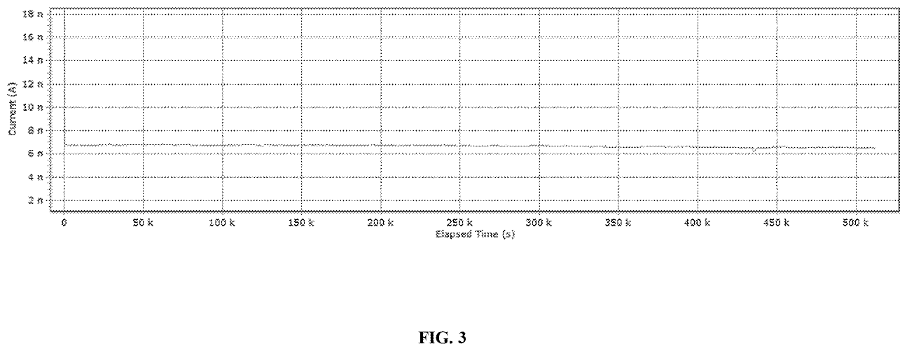

The sensing electrode was immersed in a 3 mM standard glucose solution to test its stability. FIG. 3 is a graph showing the relationship between the test time and the current intensity provided in embodiment 4. Referring to FIG. 3, the sensor's signal attenuation averaged only 0.5% every 24 h over a 6-day period, indicating that the sensor membrane prepared through the method described in the present disclosure has excellent stability.

In some embodiments, the redox complex is represented by formula I:
R is each independently selected from a group consisting of a C₁-C₄ alkylene chain, ethylene, 1,3-propylene (—CH2-CH2-CH2-), 1,2-propylene (—CH2-CH(CH3)-) and 1,4-butylene (—CH2-CH2-CH2-CH2-).

X is each independently selected from a group consisting of hydroxyl, amino, ethenyl, alkynyl, azido, cyano, carboxyl, hydroxymethyl, sulfhydryl, isocyanate group, —R^{a}OH and —OCOR^{b}; wherein, R^{a} is each independently methylene or ethylidene (—CH₂—CH₂—); R is a C₁-C₃ alkyl. In another embodiments, R¹ is each independently —CH═CH₂ or —CH═CHCH₃.

R¹, R², R³ and R⁴ are each independently hydrogen (H) or alkyl; M is the transition metal; n is the number of counter cations; A is a counterion.

The structure of L₂ is represented by formula II:

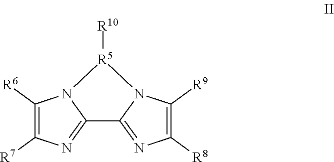

R⁵ is each independently C₁-C₄ alkylene chain or ortho-substituted benzene ring; R¹⁰ is each independently hydrogen (H), —CH₃ or —CH₂CH₃; R⁶, R⁷, R⁸ and R⁹ are each independently hydrogen (H) or alkyl.

In some embodiments, the structure of the redox complex is represented by formula III:

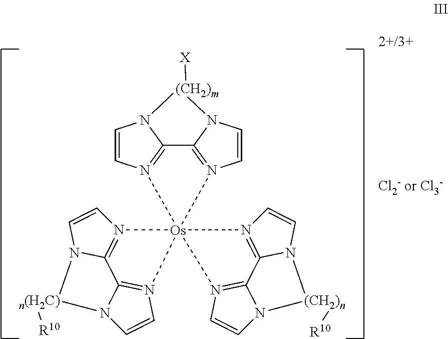

m is 2, 3, or 4; n is each independently 2, 3, 4 or ortho-substituted benzene ring.

X is hydroxyl, amino, ethenyl, alkynyl, azido, cyano, carboxyl, hydroxymethyl, sulfhydryl, isocyanate group, —R^{a}OH or —OCOR^{b}; wherein, X is hydroxyl, amino, ethenyl, alkynyl, azido, cyano, carboxyl, hydroxymethyl, sulfhydryl, isocyanate group, —R^{a}OH or —OCOR^{b}; R^{b} is each independently —CH═CH₂, —CH═CHCH₃ or —CH₂CH₂COOH.

R¹⁰ is each independently hydrogen (H), —CH₃ or —CH₂CH₃.

In some embodiments, the backbone polymer includes one or more of poly(glycidyl methacrylate), poly(glycidyl acrylate), poly(ethylene glycol-co-glycidyl acrylate), poly(hydroxyethyl acrylate-co-glycidyl acrylate), poly(hydroxyethyl methacrylate-co-glycidyl acrylate), poly(hydroxyethyl acrylate-co-glycidyl methacrylate), and poly(hydroxyethyl methacrylate-co-glycidyl methacrylate).

The above description is only used to understand the method and core idea of the present application. It should be pointed out that for ordinary technicians in this technical field, several improvements and modifications can be made to the present application without departing from the principles of the present application, and these improvements and modifications also fall within the scope of protection of the rights of the present application.

What is claimed is:

1. A redox complex, the redox complex represented by the following formula I: 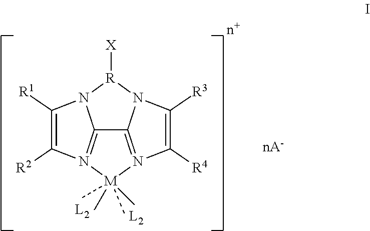
wherein, in formula I,
R is a C₁-C₄ alkylene chain;
X is each independently selected from a group consisting of hydroxyl, amino, ethenyl, alkynyl, azido, cyano, carboxyl, hydroxymethyl, sulfhydryl, isocyanate group, —R^{a}OH and —OCOR^{b};
R^{a} is each independently methylene (—CH₂—) or ethylene (—CH₂—CH₂—);
R^{b} is a C₁-C₃ alkyl;
R¹, R², R³ and R⁴ are each independently hydrogen (H) or alkyl;
M is a transition metal;
n is the number of counter cations;
A is a counterion;
wherein the structure of L₂ represented by the following formula II: 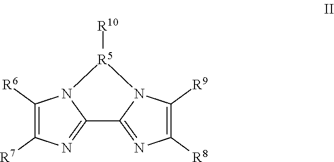
in formula II,
R⁵ is each independently C₁-C₄ alkylene chain or ortho-substituted benzene ring;
R¹⁰ is each independently hydrogen (H), —CH₃ or —CH₂CH₃;
R⁶, R⁷, R⁸ and R⁹ are each independently hydrogen (H) or alkyl.

2. The redox complex according to claim 1, wherein the transition metal is each independently selected from a group consisting of iron (Fe), cobalt (Co), ruthenium (Ru), osmium (Os) and vanadium (V).

3. The redox complex according to claim 1, wherein the counterion is each independently chloride ion or hexafluorophosphate.

4. The redox complex according to claim 1, wherein R is each independently selected from a group consisting of ethylene (—CH₂—CH₂—), 1,3-propylene (—CH₂—CH₂—CH₂—), 1,2-propylene (—CH₂—CH(CH₃)—), and 1,4-butylene (—CH₂—CH₂—CH₂—CH₂—).

5. The redox complex according to claim 1, wherein R¹, R², R³ and R⁴ are each independently hydrogen (H) or methyl.

6. The redox complex according to claim 1, wherein R⁶, R⁷, R⁸ and R⁹ are each independently hydrogen (H) or methyl.

7. The redox complex according to claim 1, wherein R^{b} is each independently —CH═CH₂ or —CH═CHCH₃.

8. The redox complex according to claim 1, wherein the redox complex represented by the following formula III: 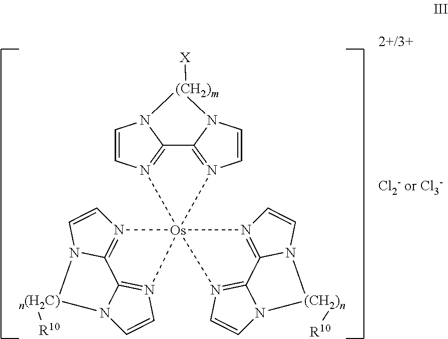
wherein m is 2, 3, or 4;
n is each independently 2, 3, 4 or ortho-substituted benzene ring;
X is hydroxyl, amino, ethenyl, alkynyl, azido, cyano, carboxyl, hydroxymethyl, sulfhydryl, isocyanate group, —R^{a}OH or —OCOR^{b}; and
R^{a} is each independently methylene (—CH₂—) or ethylene (—CH₂—CH₂—);
R^{b} is each independently —CH═CH₂, —CH═CHCH₃ or —CH₂CH₂COOH;
R¹⁰ is each independently hydrogen (H), —CH₃ or —CH₂CH₃.

9. The redox complex according to claim 1, wherein the redox complex represented by formulas (1) to (21):

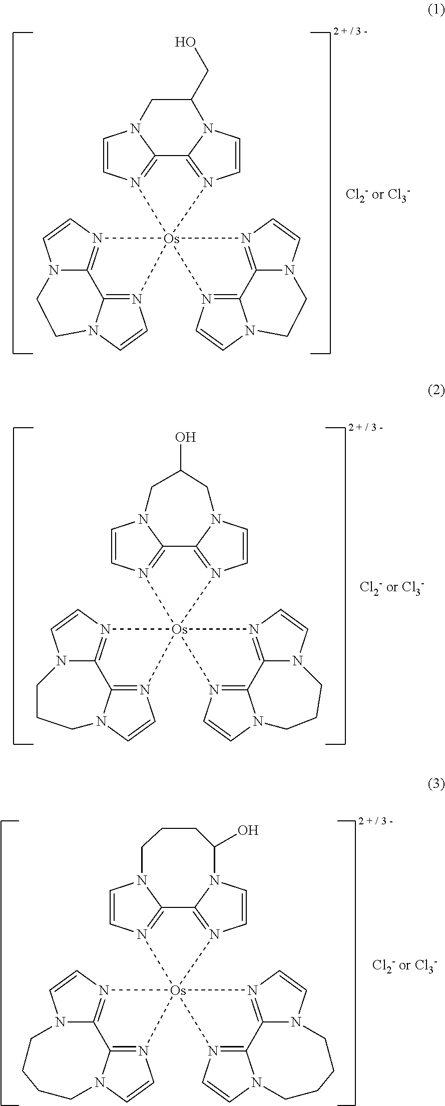

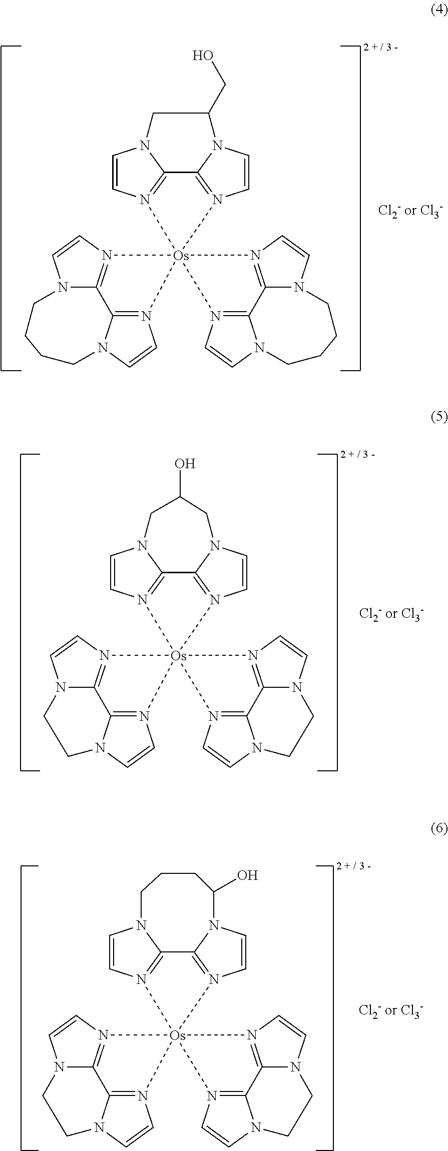

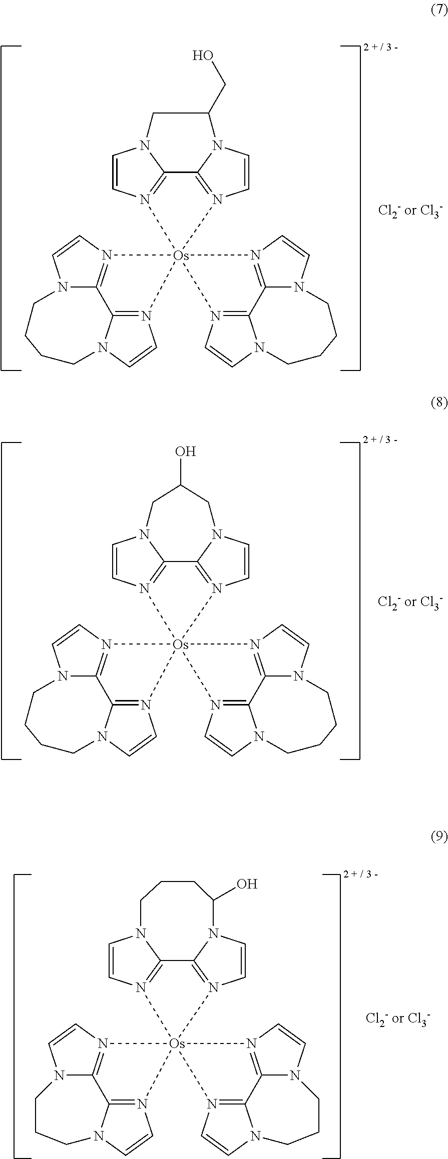

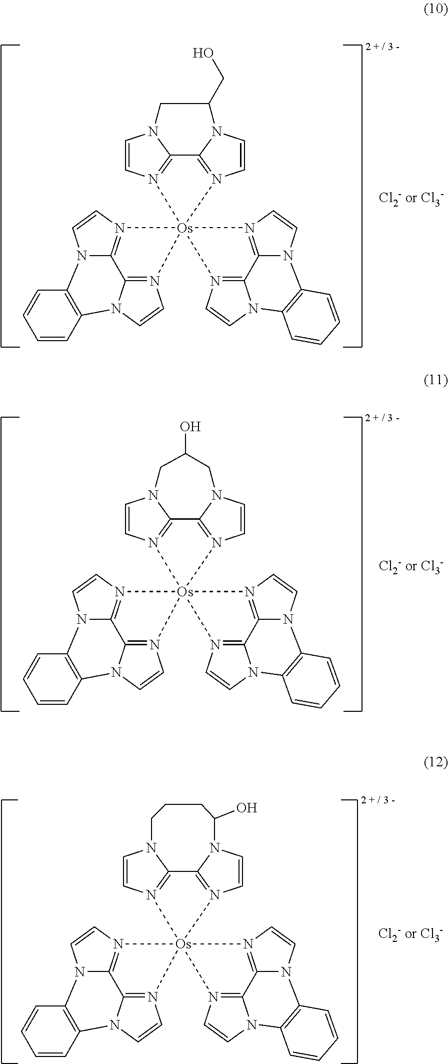

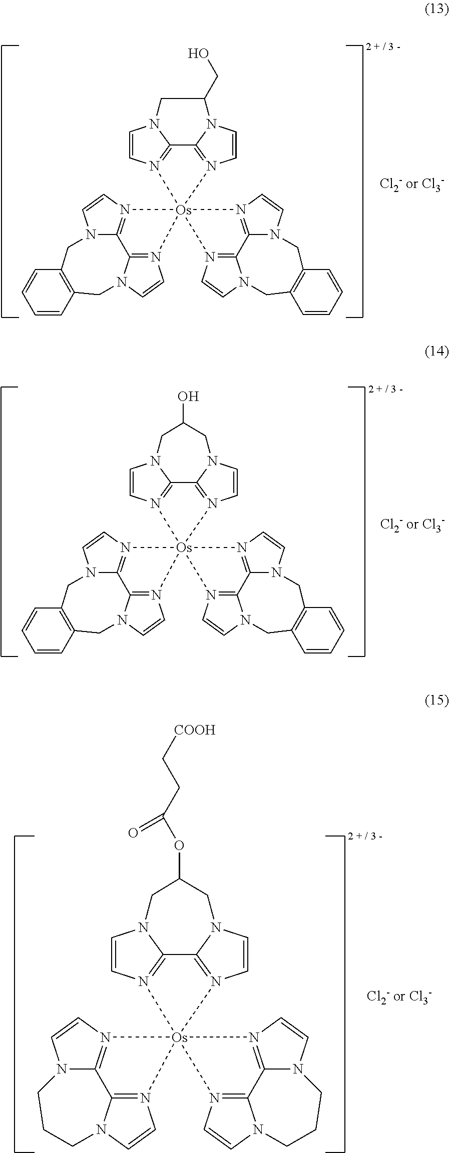

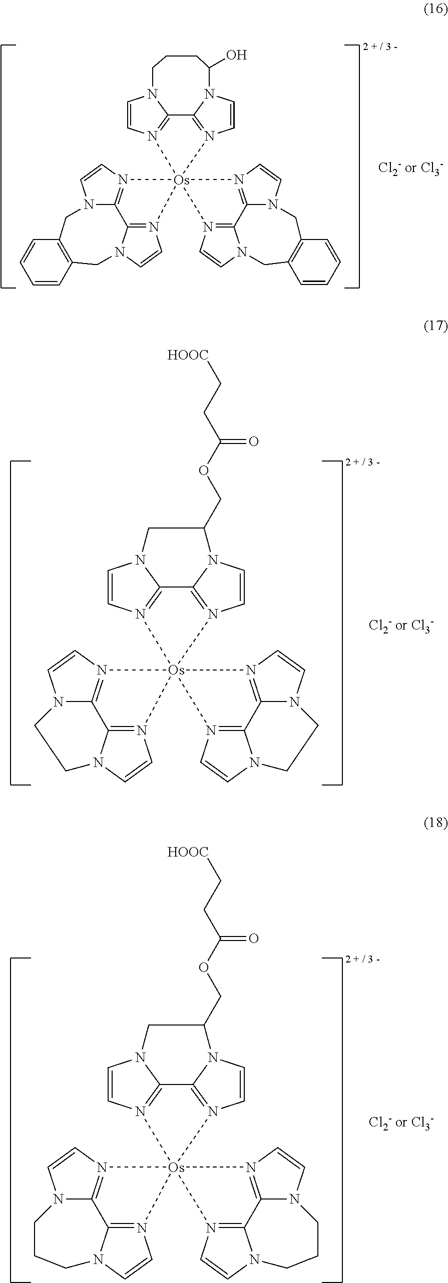

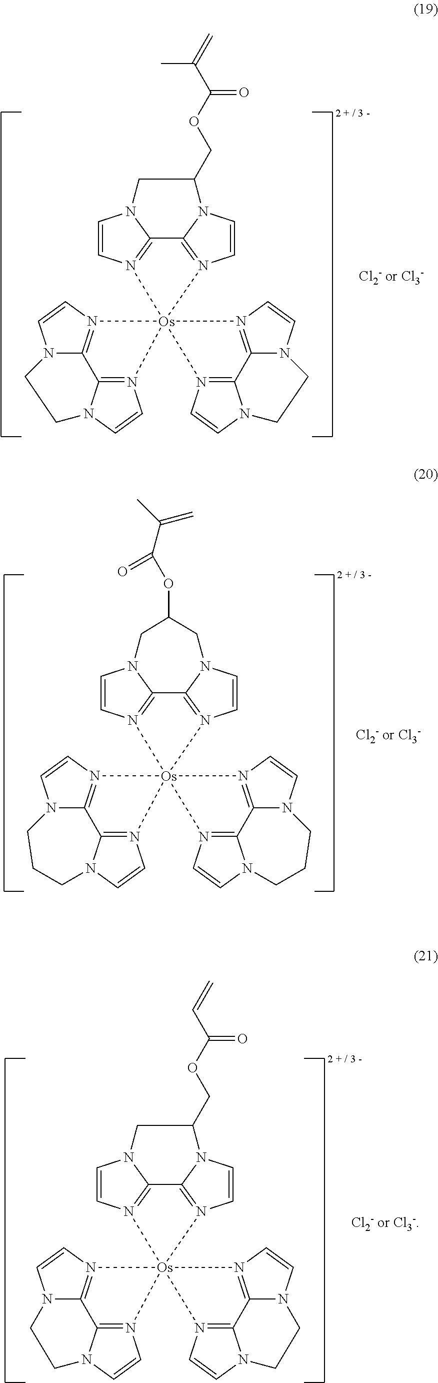

10. A method for preparing a sensing layer solution, wherein comprising the following steps:
The redox complex as claimed in claim 1, an oxidase and a backbone polymer are dissolved in a HEPES buffer solution to obtain the sensing layer solution.

11. The method according to claim 10, wherein the backbone polymer comprises one or more of poly(glycidyl methacrylate), poly(glycidyl acrylate), poly(ethylene glycol-co-glycidyl acrylate), poly(hydroxyethyl acrylate-co-glycidyl acrylate), poly(hydroxyethyl methacrylate-co-glycidyl acrylate), poly(hydroxyethyl acrylate-co-glycidyl methacrylate), and poly(hydroxyethyl methacrylate-co-glycidyl methacrylate).

12. A method for preparing a sensing electrode, wherein comprising the following steps:
The sensing layer solution prepared according to claim 10 is applied onto a surface of a carbon electrode by spray-coating, drop-coating or dip-coating;
an outer membrane layer is applied onto the surface of the carbon electrode comprising a sensing layer by spray-coating or dip-coating to prepare the sensing electrode.
